(19) United States
(12) Patent Application Publication
(10) Pub. No.: US 2023/0109746 A1
(43) Pub. Date: Apr. 13, 2023

(54) DRIVE ASSEMBLY FOR THE MOTORISED ADJUSTMENT OF AN ADJUSTING ELEMENT OF A MOTOR VEHICLE

(71) Applicant: Brose Fahrzeugteile SE & Co. Kommanditgesellschaft, Bamberg, Bamberg (DE)

(72) Inventors: Melanie ANGERMÜLLER, Heldburg (DE); Nils HANNEMANN, Hallstadt (DE); Daniel SCHNAPP, Ebensfeld (DE); Johannes BARTOSCHEK, Bamberg (DE)

(73) Assignee: Brose Fahrzeugteile SE & Co. Kommanditgesellschaft, Bamberg, Bamberg (DE)

(21) Appl. No.: 17/800,579

(22) PCT Filed: Feb. 16, 2021
(86) PCT No.: PCT/EP2021/053696

§ 371 Date: Aug. 18, 2022

(30) Foreign Application Priority Data
Feb. 18, 2020 (DE) 10 2020 104 212.4

(51) Int. Cl. E05F 15/622

(52) U.S. Cl. CPC E05F 15/622; E05Y 2900/50; E05Y 2201/704; E05Y 2400/336

(57) ABSTRACT

A drive arrangement configured to provide motorized adjustment of an adjusting element of a motor vehicle and including a motor, a driveshaft extending from the motor, an output shaft, a spindle configured to translate to adjust the adjusting element, a coupling configured to selectively couple and decouple the spindle from the motor, the coupling, a housing, and a sensor. The coupling including a coupling element configured to generate a signal indicative of rotation angle of the coupling element. The coupling, the output shaft and at least a portion of the driveshaft disposed in the housing. The sensor disposed in the housing and configured to detect the signal.

### CROSS-REFERENCE TO RELATED APPLICATIONS

This application is the U.S. National Phase of PCT Application No. PCT/EP2021/053696 filed on Feb. 16, 2021, which claims priority to German Patent Application No. DE 10 2020 104 212.4, filed on Feb. 18, 2020, the disclosures of which are hereby incorporated in their entirety by reference herein.

### TECHNICAL FIELD

The present disclosure relates to a drive arrangement for the motorized adjustment of an adjusting element.

### BACKGROUND

Within the context of increasing the comfort in motor vehicles, the motorized adjustment of adjusting elements is given special significance. An adjusting element can be a closing element, for example a side door. Other types of closing elements are, for example, trunk lids, front hoods, tailgates or the like. An adjusting element can also, however, be an adjustable seat part such as a backrest or the like.

### SUMMARY

The present disclosure may address one or more problems by configuring and developing a drive arrangement in such a way that the necessary installation space is reduced.

In one or more embodiments, the drive arrangement includes an encoder element of a movement detection device with a coupling element of the coupling of the drive to form one component. And therefore of producing a single component from two components of different functions which have up to now been separate and spaced apart from one another, which single component combines two functions, namely firstly the detection of a rotational movement and secondly the coupling function. In this way, the axial dimensions of the drive arrangement and accordingly the necessary installation space in the motor vehicle can be reduced.

As an example, the drive arrangement has a movement detection device with at least one sensor and an encoder element which interacts with it, that the at least one sensor is fixed to the housing, and that the encoder element is arranged fixedly on one of the coupling elements for conjoint rotation.

As has already been explained in the introductory part of the description, a movement detection device of this type permits, by way of the interaction between the encoder element and a respective sensor, the detection of angular changes of the driveshaft which rotates about its geometric rotational axis. Via this, the rotational speed (rpm), angular position (degrees) and/or rotational direction (clockwise direction/counterclockwise direction) of the driveshaft can be determined, and the degree of the adjustment of the advancing mechanism during its adjusting movement can therefore be extrapolated. A movement detection device of this type therefore forms a rotary encoder, such as an incremental encoder, the encoder element having markings which can be detected by sensor, on the basis of which rotationally induced angular changes can be detected. The markings may be configured, for example, in such a way that they can be detected by a magnetic field sensor, a capacitive sensor and/or an inductive sensor. In this context, a marking which can be detected by magnetic field sensor is, for example, a magnetic pole of a permanent magnet or ring magnet. In this context, a marking which can be detected by a capacitive or inductive sensor is, for example, ferromagnetic metal piece. Markings of this type may be arranged distributed over the circumference of the encoder element, in particular at uniform spacings.

One or more embodiments relate to movement detection devices, specifically of the at least one sensor and the respective encoder element.

As an example, a number of markings which can be detected by sensor on the encoder element may be provided. This in turn determines the measuring resolution of the movement detection device.

One or more embodiments relate to positions of the encoder element relative to the coupling element, on which it is arranged. Furthermore, connecting types between the encoder element and the coupling element are defined.

One or more embodiments relate to positions of the at least one sensor relative to the encoder element.

Other embodiments relate to the coupling and the coupling elements. The coupling may be a curved tooth coupling, other coupling types also being conceivable, however, such as a cross slide coupling, a claw coupling, an elastomeric coupling or the like.

The driveshaft is a shaft of the motor unit and, in accordance with another embodiment, the output shaft is a shaft of the motor unit or the advancing mechanism.

In another embodiment, the advancing mechanism is a spindle/spindle nut mechanism.

In one or more embodiments, a drive housing of the drive is provided. The drive housing serves to receive the motor unit and/or the advancing mechanism and/or the coupling element with the encoder element.

In another embodiment, an adjusting element arrangement with an adjusting element, such as a closing element of a motor vehicle and with a drive arrangement as described above is provided. To this extent, reference may be made to all the comments in respect of the drive arrangement according to the proposal.

### BRIEF DESCRIPTION OF THE DRAWINGS

In the following text, the invention will be explained in greater detail on the basis of the drawing which illustrates merely exemplary embodiments, and in which:

FIG. 1 shows the rear region of a motor vehicle with an adjusting element arrangement according to the proposal which is equipped with a drive arrangement according to the proposal,

FIG. 2 shows the drive arrangement according to FIG. 1 in a partial illustration,

FIG. 3 shows the drive arrangement according to FIG. 1 in a perspective view with an enlargement of a detail,

FIG. 4 shows a sectional view of a part of the drive arrangement according to FIG. 1, and

FIG. 5 shows sectional views of a coupling of the drive arrangement according to FIG. 1 a) in accordance with a first exemplary embodiment, and b) in accordance with a second exemplary embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known drive arrangement is provided in DE 10 2017 115 464 A1), the drive arrangement provides motorized adjustment of a closing element in the form of a tailgate of a motor vehicle. The drive arrangement has a drive unit with a drive which has a rotational motor unit and an advancing mechanism which is connected downstream in drive terms of the motor unit for generating linear drive movements for opening and closing of the closing element. Here, the advancing mechanism as a spindle/spindle nut mechanism with a spindle and a spindle nut which meshes with it. Furthermore, the drive of this drive arrangement has a claw coupling with two coupling elements, of which one coupling element is connected to a driveshaft and the other coupling element is connected to an output shaft of the drive. Here, the driveshaft is a gear mechanism output shaft of an intermediate gear mechanism of the motor unit, which intermediate gear mechanism couples the gear mechanism output shaft in drive terms to the motor shaft. Here, the output shaft is the spindle of the spindle/spindle nut mechanism.

For the detection of rotational movements and angular changes of the driveshaft, it is known for a ring magnets to be connected fixedly to the driveshaft, spaced apart axially from the coupling, for conjoint rotation, which ring magnets interacts with a Hall sensor in such a way that, in the case of a rotating driveshaft, by way of which the ring magnet and its magnetic field is corotated, magnetic field changes are detected. Via this, the rotational speed and angular position of the driveshaft can be determined and the degree of the adjustment of the advancing mechanism, that is to say the position of the spindle relative to the spindle nut, during the entire adjusting movement can be extrapolated. The use of a movement detection device of this type increases the necessary installation space read drive arrangement of this type, however.

The drive arrangement 1 according to the proposal serves for the motorized adjustment of an adjusting element 2 (here, a closing element) of a motor vehicle. The adjusting element 2 can be adjusted by means of the drive arrangement 1 in a first adjusting direction (here, an opening direction) and in a second adjusting direction (here, a closing direction).

Here, purely by way of example, the adjusting element 2 in the form of the closing element is a trunk lid of the motor vehicle. The drive arrangement 1 according to the proposal can also fundamentally be applied with the same advantages, however, to different types of adjusting elements, in particular closing elements, of a motor vehicle. These include, inter alia, tailgates, rear doors, front hoods and side doors of the motor vehicle. Reference is to be made to the list in the introductory part of the description with regard to further advantageous adjusting elements.

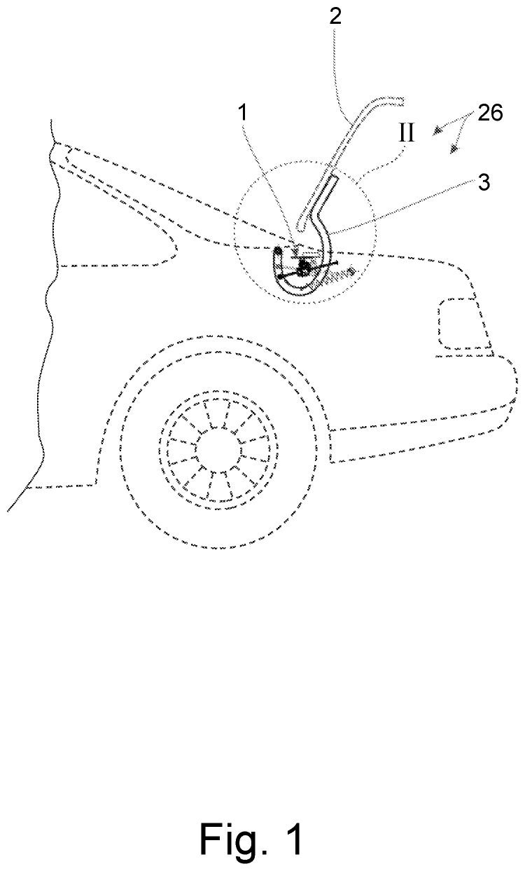

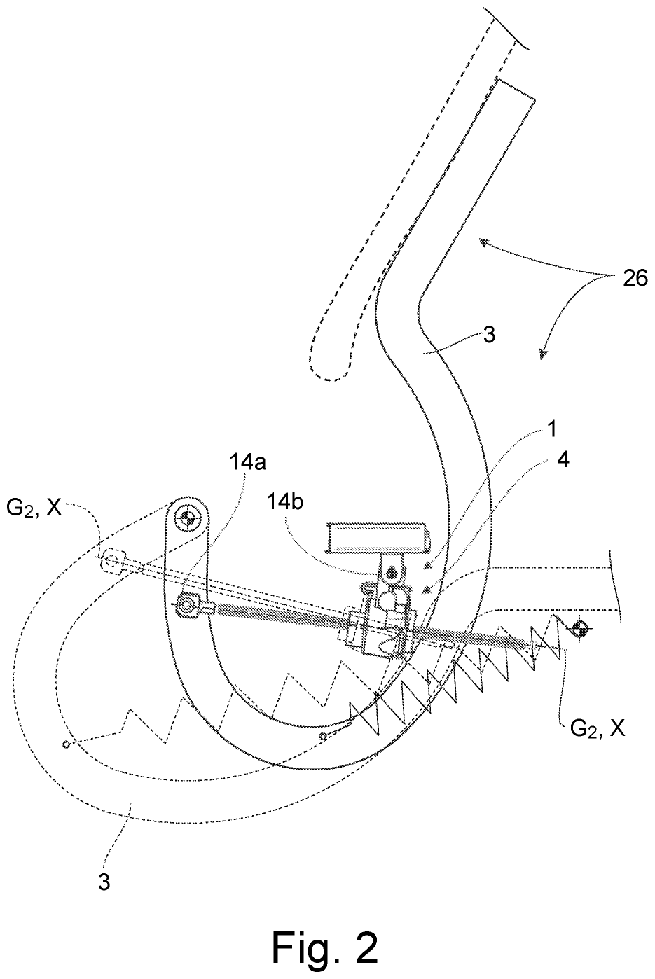

Viewing FIGS. 1 and 2 together shows that, in the assembled state here, the drive arrangement 1 acts, for example, on a motion link 3 which is assigned to the adjusting element 2. The drive arrangement 1 can fundamentally also act directly on the adjusting element 2.

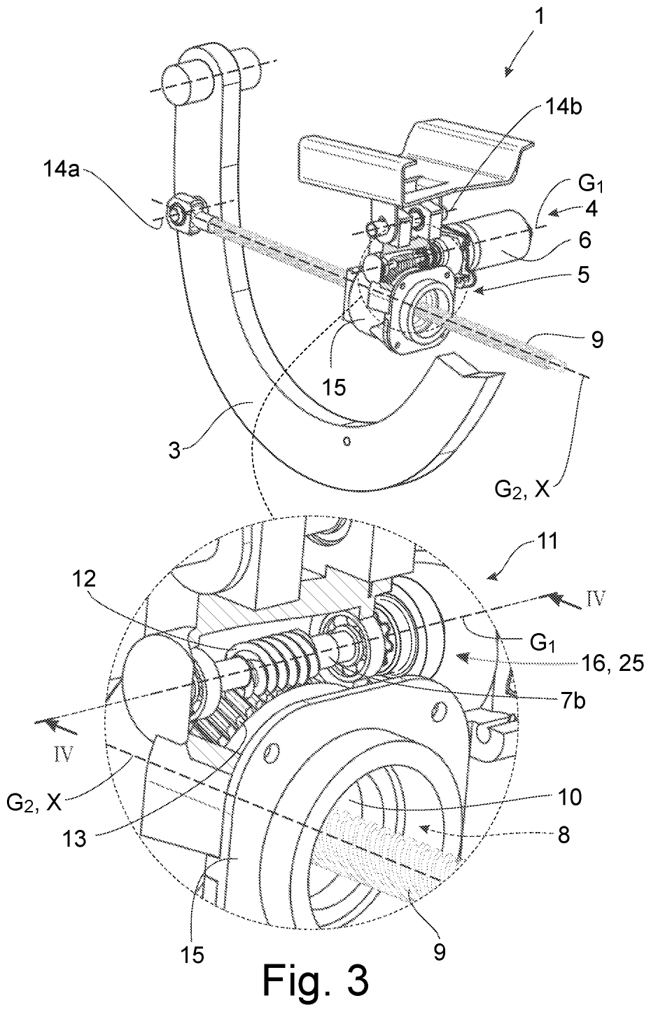

The drive arrangement 1 has a drive unit 4 with a drive 5. The drive 5 per se is shown on an enlarged scale in the perspective illustration according to FIG. 3. As an example, the adjusting element 2 is assigned only a single drive unit 4. The adjusting element 2 can fundamentally also be assigned two drive units 4, however, which can be arranged on the two opposite sides of the motor vehicle trunk in the case of the exemplary embodiment which is shown here. The two drive units 4 may be of identical or mirror-inverted configuration with respect to one another.

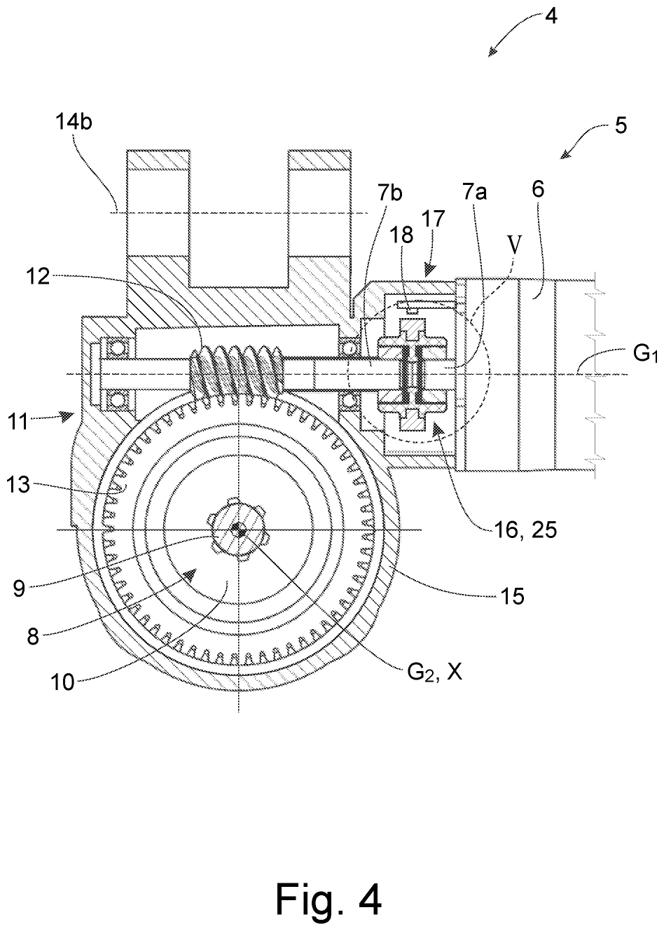

FIGS. 3 and 4 show that the drive 5 has a rotational motor unit 6 with an output shaft 7b. In the present case, the term “rotational” means that the motor unit 6 outputs drive movements via the output shaft 7b.

FIG. 3 shows, moreover, that an advancing mechanism 8 (here, in the form of a spindle/spindle nut mechanism) for generating drive movements along a geometric advancing mechanism axis X in a first adjusting direction which corresponds, in particular, to opening of the closing element and in a second adjusting direction which corresponds, in particular, to closing of the closing element is connected downstream of the motor unit 6. The spindle/spindle nut mechanism has a spindle 9 which meshes with a spindle nut 10 in a way which is routine per se. Here, the motor unit 6 is coupled in drive terms to the spindle nut 10 and transmits a torque to the latter, the spindle nut 10 then in turn setting the spindle 9 in linear movements.

Furthermore, FIGS. 3 and 4 show merely by way of example a worm gear stage 11 which is connected in drive terms here between the motor unit 6 and the advancing mechanism 8. The worm gear stage 11 has a worm 12 which is coupled to the output shaft 7b of the motor unit 6, and a worm gear 13 which meshes with the worm 12 in a way which is likewise routine per se and, for example, forms a common component with the spindle nut 10. Here, the worm 12 can be rotated about a first gear axis G₁ and the worm gear 13 which meshes with it can be rotated about a second gear axis G₂ which runs transversely and, in particular, orthogonally with respect to the first gear axis G₁.

The motor unit 6, the optional worm gear stage 11 and the advancing mechanism 8 are arranged on a drive train of the drive arrangement 1, which drive train serves for the transmission of torque from the motor unit 6 to the spindle 9 which can be moved in a linear manner as a result and in this way moves two drive connectors 14a, 14b of the drive arrangement 1 relative to one another. The one drive connector 14a connects the spindle 9 pivotably to the adjusting element 2 or, as in the present exemplary embodiment, to the motion link 3 which is assigned to the adjusting element 2, whereas the other drive connector 14b otherwise connects the drive unit 4 pivotably to the motor vehicle, in particular via a drive housing 15 of the drive 5. In the present case, the term “drive housing” is to be understood broadly and also quite generally comprises a carrier which supports the motor unit 6 and/or the advancing mechanism 8. A drive housing 15 of this type does not necessarily have to be completely closed here.

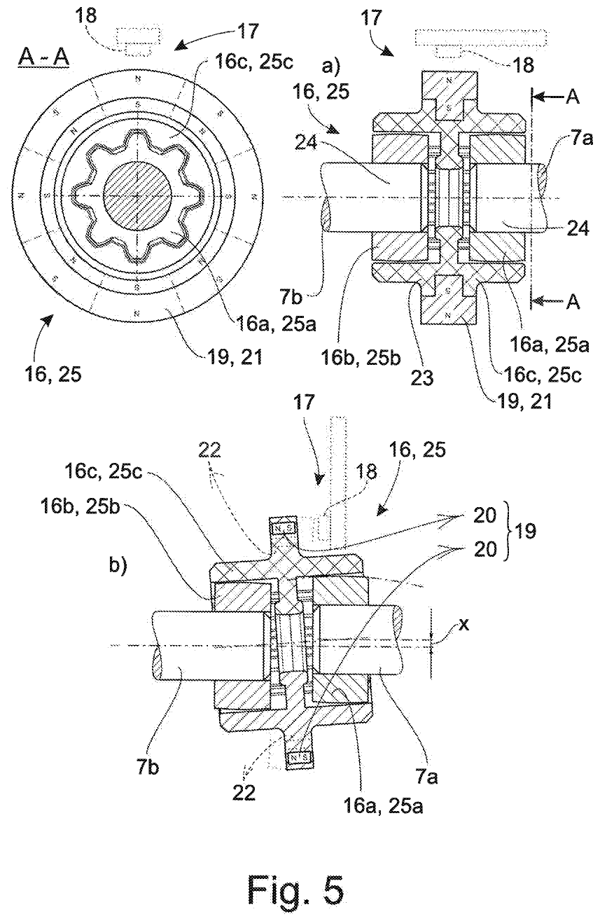

Furthermore, as shown in FIGS. 4 and 5, the drive 5 has a coupling 16 with at least two coupling elements 16a, 16b, 16c, of which a first coupling element 16a is connected fixedly to a driveshaft 7a of the drive 5 for conjoint rotation and a second coupling element 16b is connected fixedly to an output shaft 7b of the drive 5 for conjoint rotation. Here, the first coupling element 16a and/or the second coupling element 16b may be formed of a plastic material. A third coupling element 16c is also provided here which is likewise preferably configured from a plastic material and will be described in greater detail in the further text.

Here and preferably, the driveshaft 7a is the motor shaft and, as an example, the driveshaft 7b may be the abovementioned output shaft which introduces the rotational movements into the advancing mechanism 8.

In the state in which they are coupled to one another in drive terms, the at least two coupling elements 16a, 16b, 16c transmit rotational movements from the driveshaft 7a to the output shaft 7b which brings about the drive movements of the advancing mechanism 8.

The drive arrangement 1 may include a movement detection device 17 with at least one sensor 18 and an encoder element 19 which interacts with it for the detection of a rotational movement of the driveshaft 7a, that the at least one sensor 18 is fixed to the housing, and that the encoder element 19 is arranged fixedly on one of the coupling elements 16a, 16b, 16c for conjoint rotation. The interaction between the encoder element 19 and the at least one sensor 18 is such that angular changes of the rotating driveshaft 7a can be detected and the rotational speed, angular position and/or rotational direction of the driveshaft 7a can be determined via this, which in turn allows an extrapolation of the degree of the adjustment of the advancing mechanism 8, that is to say of the position of the spindle 9 relative to the spindle nut 10 and the position of the drive connectors 14a, 14b relative to one another.

In one or more embodiments, the at least one sensor 18 is a magnetic field sensor, in particular a Hall sensor or MR sensor (magneto resistive sensor). Here, the encoder element 19 can be configured in different ways and, in particular, can have one or more individual permanent magnets 20 or a multi-polar ring magnet 21. “Multi-polar” means that the polls N, S (north poles N and south poles S) of the magnet alternate in the circumferential direction, that is to say this magnet has a plurality of poles N, S distributed over the circumference. Here, the “circumference” is always in relation to the circumference of the respective coupling element (here, the coupling element 16c) about its rotational axis.

In the case of the exemplary embodiment in FIG. 5a), for example, a multi-polar ring magnet 21 of this type is provided, that is to say a ring magnet 21 which, as shown in the section A-A, has poles N, S which alternate over the circumference. In contrast, FIG. 5b) shows a plurality of permanent magnets 20 which are arranged distributed over the circumference of the coupling element 16c, the arrangement of the permanent magnets 20 also being selected here in such a way that the magnetic poles N, S alternate over the circumference. The magnetic poles of the same orientation (that is to say, for example, the north poles N) then form markings which can be detected by sensor on the encoder element 19.

In accordance with one alternative exemplary embodiment which is shown in FIG. 5b) by way of dashed lines, the at least one sensor 18 can also be a capacitive or inductive sensor, the encoder element 19 having one or a plurality of individual metal pieces 22. The plurality of individual metal pieces 22 are then arranged distributed over the circumference of the coupling element 16c. As an alternative, it is also conceivable that the encoder element 19 is toothed over the circumference. In the former case, the metal pieces and, in the latter case, the teeth, can be detected capacitively or inductively, that is to say form the markings which can be detected by sensor.

The encoder element 19 can have a number of permanent magnets 20 or metal pieces 22 or magnetic poles N or south poles S in the range from 2 to 100 in the circumferential direction. For a relatively precise positional determination, the number lies in the range from 10 to 50, or in the range from 20 to 40.

The encoder element 19 can be placed radially on the outer side onto the respective coupling element (here, the coupling element 16c, or can be embedded into the coupling element at least partially (FIG. 5a)), in particular for the most part (FIG. 5b)) or completely. “Embedded” means that the encoder element 19, in particular the ring magnet 21, the permanent magnets 20 or the metal pieces 22 are encapsulated at least partially by the material of the coupling element 16c. This can be achieved, for example, by virtue of the fact that the permanent magnets 20 or metal pieces 22 are cast into the coupling element 16c during the production of the latter, or, after the production of the coupling element 16c, are inserted into corresponding cutouts, for example bores. In the case of the use of a ring magnet 21, the coupling element 16c can also be molded onto this ring magnet 21, in particular radially on the inner side. The encoder element 19 may be connected to the coupling element 16c in an integrally joined, positively locking and/or non-positive manner. As an example, it can be latched or adhesively bonded to the coupling element or can be cast into the coupling element.

The at least one sensor 18 can likewise be arranged in different ways. The at least one sensor 18 may be arranged axially or radially with respect to the encoder element 19. A radial arrangement of the only sensor 18 here with respect to the encoder element 19 is shown by way of example in FIG. 5a), and an axial arrangement is shown in FIG. 5b). A plurality of sensors 18 of this type can also be provided which can be arranged in each case axially or radially with respect to the encoder element 19.

In the following text, the coupling 16 is now to be explained in greater detail. In one or more embodiments, the coupling element 16c, on which the encoder element 19 is arranged, is a sleeve-shaped element 23, but can also be an axial shaft portion 24, for example, of the driveshaft 7a or the output shaft 7b. In principle, the coupling element can also be a gearwheel 25a, 25b which may be arranged on a shaft portion 24, such as of the driveshaft 7a or output shaft 7b.

In one or more embodiments, the coupling 16 is a non-switchable coupling 16, but can also be a switchable coupling in accordance with one alternative embodiment which is not shown here. In addition or as an alternative, the coupling 16 can be a torsionally rigid or torsionally flexible coupling 16.

In one or more embodiments, the coupling 16 is a curved tooth coupling 25, other coupling types also being conceivable, however.

A curved tooth coupling 25 has the advantage that it can compensate for an axial offset and/or an angular offset between the driveshaft 7a and the output shaft 7b or their rotational axes. This permits simplified assembly and the compensation of tolerances due to manufacture and assembly.

A curved tooth coupling 25 has two externally toothed coupling elements 16a, 16b, of which one is provided fixedly on the driveshaft 7a for conjoint rotation and the other is provided fixedly on the output shaft 7b for conjoint rotation. The externally toothed coupling element 16a, 16b can be configured as a gearwheel 25a, 25b or as a shaft portion 24 which is provided with an external toothing system. Furthermore, the curved tooth coupling 25 has a coupling element 16c in the form of an internally toothed internal gear 25c which is coupled or can be coupled in drive terms to the two externally toothed coupling elements 16a, 16b. The externally toothed coupling elements 16a, 16b are mounted in the internally toothed internal gear 25c such that they can be tilted, to be precise in each case about a tilt axis which is orthogonal with respect to the rotational axis of the respective shaft 7a or 7b. For this purpose, the coupling elements 16a, 16b may be of crowned configuration, that is to say are rounded on the respective radial outer side around the tilt axis.

In one or more embodiments, the coupling element 16c, in particular the sleeve-shaped element 23, on which the encoder element 19 is arranged, is the internally toothed internal gear 25c of the curved tooth coupling 25. It is also conceivable, however, that one of the externally toothed coupling elements 16a, 16b of the curved tooth coupling 25 forms the coupling element 16a and 16b, respectively, on which the encoder element 19 is arranged. Combinations are fundamentally also conceivable, in the case of which different ones of the coupling elements 16a, 16b, 16c have in each case one encoder element 19.

As FIGS. 3 and 4 show, furthermore, the driveshaft 7a, to which the first coupling element 16a is connected fixedly for conjoint rotation, may be a shaft of the motor unit 6, the driveshaft 7a being the motor shaft. It is also conceivable, however, that the driveshaft 7a is a transmission output shaft of an intermediate gear mechanism of the motor unit 6. An intermediate gear mechanism of this type is then coupled in drive terms to the motor shaft, for example.

The output shaft 7b, to which the second coupling element 16b is connected fixedly for conjoint rotation, may be likewise a shaft of the motor unit 6, but can also be a shaft of the advancing mechanism 8. As an example, the output shaft 7b is the shaft which supports the worm 12 of the worm gear stage 11, the worm gear stage 11 being connected here in drive terms between the motor unit 6 and the advancing mechanism 8, as has already been explained above. It is also fundamentally conceivable, however, that the output shaft 7b is the spindle 9 of the advancing mechanism 8.

FIG. 4 finally also shows that the drive housing 15 of the drive 5 receives, here and preferably, the motor unit 6 and/or the advancing mechanism 8 and/or the coupling element 16c, on which the encoder element 19 is arranged, such as the entire coupling 16. The drive housing 15 is preferably configured in such a way that it for the greatest part or completely surrounds the motor unit 6 and/or the advancing mechanism 8 and/or the coupling element 16c, on which the encoder element 19 is arranged, preferably the entire coupling 16. The at least one sensor 18 which may be likewise received and, for example, surrounded by the drive housing 15 is fixed firmly to the drive housing 15 here.

In accordance with a further teaching which is given independent significance, an adjusting element arrangement 26 with an adjusting element 2, in particular a closing element, of a motor vehicle and with a drive arrangement 1 according to the proposal is claimed. Reference may be made to all the comments with respect to the drive arrangement 1 according to the proposal.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

1 drive arrangement
2 element
3 motion link
4 drive unit
5 drive
6 motor unit
8 mechanism
9 spindle
10 10 spindle nut
11 worm gear stage
12 worm
13 worm gear
15 drive housing
16 coupling
17 movement detection device
18 sensors
19 encoder element
20 permanent magnets
21 ring magnet
22 metal pieces
23 sleeve-shaped element
24 shaft portion
25 curved tooth coupling
7a driveshaft
7b output shaft
14a drive connector
14b drive connector
16a coupling elements
16b coupling elements
6c coupling elements
25a gearwheel
25b gearwheel
25c internal gear

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A drive arrangement configured to provide motorized adjustment of an adjusting element of a motor vehicle, the drive arrangement comprising:
a drive unit including a drive provided with,
a driveshaft,
an output shaft
motor unit,
an advancing mechanism connected downstream of the motor unit and configured to generate drive movements along a geometric advancing mechanism axis in a first adjusting direction, in which the drive arrangement is configured to open the adjusting element, and a second adjusting direction, in which the drive arrangement is configured to close the adjusting element,
a coupling provided with at least two coupling elements including a first coupling element, fixedly connected to the driveshaft and configured to conjointly rotate with the driveshaft, and a second coupling element is fixedly connected to the output shaft and configured to conjointly rotate with the output shaft, the first and second coupling elements configured to be in a coupled state, in which rotational movements are transmitted from the driveshaft to the output shaft to generate the drive movements of the advancing mechanism;
a drive housing;
a movement detection device configured to detect rotational movement of the driveshaft, the movement detection device including,
at least one sensor fixed to the drive housing, and
an encoder element fixedly disposed on and configured to conjointly rotate with at least one of the at least two coupling elements, wherein the encoder element is configured to interact with the at least one sensor.

2. The drive arrangement of claim 1, wherein the at least one sensor is a magnetic field sensor, and the encoder element includes one or more individual permanent magnets distributed over a circumference of the coupling element.

3. The drive arrangement of claim 1, wherein the at least one sensor is a capacitive or inductive sensor, and the encoder element includes one or more individual metal pieces distributed over a circumference of the coupling element, or the circumference of the encoder element is toothed.

4. The drive arrangement of claim 1, wherein, a circumference of the encoder element includes at least one of a number of permanent magnets, a number of or metal pieces, a number of magnetic north poles, or a number of south poles, ranging between 2 and 100.

5. The drive arrangement of claim 1, wherein the encoder element is,
disposed radially on an outer side of one of the at least two coupling elements,
at least partially embedded in of one of the at least two coupling, and/or
includes a ring magnet or a number of individual permanent magnets.

6. The drive arrangement of claim 1, wherein the at least one sensor is axially spaced apart or radially spaced apart from the encoder element.

7. The drive arrangement claim 1, wherein the coupling element of the at least two coupling elements, on which the encoder element is disposed on, is a sleeve-shaped element or an axial shaft end portion.

8. The drive arrangement of claim 1, wherein the coupling is a non-switchable or a switchable coupling.

9. The drive arrangement of claim 1, wherein the coupling is a curved tooth coupling, the at least two coupling elements include a third coupling element provided with an internally toothed internal gear, and the first and second coupling elements are each externally toothed configured to be coupled to the third coupling element, and wherein at least one of the first and second coupling elements is a gearwheel disposed on the driveshaft, and/or output shaft, respectively.

10. The drive arrangement of claim 1, wherein the coupling element of the at least two coupling elements, on which the encoder element is disposed on, includes an internally toothed internal gear.

11. The drive arrangement of claim 1, wherein the driveshaft is a shaft of the motor unit or a transmission output shaft coupled to the motor unit.

12. The drive arrangement of claim 1, wherein the output shaft is a shaft of the motor unit or of the advancing mechanism.

13. The drive arrangement of claim 1, wherein the advancing mechanism is a spindle/spindle nut mechanism provided with a spindle and a spindle nut, the spindle and spindle nut in meshing engagement with each other and configured to generate the drive movements, wherein the along the spindle defines a spindle axis and the geometric advancing mechanism axis is the spindle axis.

14. The drive arrangement of claim 1, wherein the drive housing receives at least one of the motor unit, the advancing mechanism, and one of the at least two coupling elements on which the encoder element is disposed on.

15. An adjusting element arrangement with an adjusting element, in particular closing element, of a motor vehicle and with a drive arrangement of claim 1.

16. The drive arrangement of claim 1, wherein a circumference of the encoder element includes at least one of a number of permanent magnets, a number of metal pieces, a number of magnetic north poles, or a number of south poles, ranging between 20 and 40.

17. The drive arrangement of claim 1, wherein the coupling is a torsionally rigid and/or torsionally flexible coupling and/or the coupling is a curved tooth coupling.

18. A drive arrangement configured to provide motorized adjustment of an adjusting element of a motor vehicle, the drive arrangement comprising:
a motor;
a driveshaft extending from the motor;
an output shaft;
a spindle configured to translate to adjust the adjusting element;
a coupling configured to selectively couple and decouple the spindle from the motor, the coupling including a number of coupling elements, wherein a coupling element of the number of coupling elements is configured to generate a signal indicative of rotation angle of the coupling element;
a housing, the coupling, the output shaft and at least a portion of the driveshaft disposed in the housing; and
a sensor disposed in the housing and configured to detect the signal.

19. The drive arrangement of claim 18, wherein the sensor is radially disposed between a portion of the housing and the coupling element.

20. The drive arrangement of claim 18, wherein the coupling element includes a number of permanent magnets circumferentially embedded in the coupling element.
